(19) United States
(12) Patent Application Publication
(10) Pub. No.: US 2015/0124451 A1
(43) Pub. Date: May 7, 2015

(54) MOUNTING SUPPORT FOR SOLID-STATE LIGHT RADIATION SOURCES AND LIGHT SOURCE THEREFOR

(71) Applicant: OSRAM GmbH, Muenchen (DE)

(72) Inventors: Franco Zanon, Cassola (IT); Alessio Griffoni, Fosso (IT); Lorenzo Roberto Trevisanello, Abano Terme (PD) (IT); Matteo Caldon, Vigonovo (IT)

(21) Appl. No.: 14/399,216

(22) PCT Filed: May 7, 2013
(86) PCT No.: PCT/EP2013/059446

§ 371 Date: Nov. 6, 2014

(30) Foreign Application Priority Data
May 7, 2012 (IT) TO2012A000404

(51) Int. Cl. F21V 19/00; F21V 23/00

(52) U.S. Cl. CPC F21V 19/001; F21V 23/005
USPC 362/249.02; 362/382; 362/249.01

(57) ABSTRACT

A mounting support for solid-state light radiation sources and for drive circuitry associated therewith may include a printed circuit board having a mounting surface for the light radiation sources, the printed circuit board having at least one through hole extending through it, and at least one electrical component of the drive circuitry inserted in the at least one hole.

### RELATED APPLICATIONS

The present application is a national stage entry according to 35 U.S.C. §371 of PCT application No.: PCT/EP2013/059446 filed on May 7, 2013, which claims priority from Italian application No.: TO2012A000404 filed on May 7, 2012, and is incorporated herein by reference in its entirety.

### TECHNICAL FIELD

Various embodiments generally relate to mounting supports for solid-state light radiation sources.

Various embodiments may relate to light sources using LED sources as light radiation sources.

### BACKGROUND

In the design of solid-state lighting modules such as high-flux LED modules, heat dissipation is a factor that must be taken into account in order to limit optical losses and the effects of accelerated aging.

For this reason, mounting structures based, for example, on the use of printed circuit boards (PCBs) with a high degree of thermal conductivity have been developed.

The effect of heat dissipation from the light source can be improved, particularly in the case of coupling to a heat sink, by increasing the spacing (pitch) between the radiation sources (for example, the spacing between adjacent LEDs), resulting in an increase in the surface dimensions.

For other types, it is desirable for the light emitting surface (LES) of the source to be exclusively populated, for practical purposes, by light radiation sources (such as LEDs, possibly in a chip on board or “CoB” configuration), with the associated drive circuitry located in another area of the board which is separate from the light emitting surface. In the case of very closely spaced arrays of light radiation sources, the area of the board available for the other components may therefore be extremely limited (as in compact modules, for example).

In order to limit the aforementioned negative effects, “buried” components may be used.

This approach makes the board manufacturing process rather complicated and costly, and the components of the drive circuitry are provided by the board manufacturer, resulting in limitations on the light source manufacturer' s freedom of use of the support. For example, if different versions of the same product are to be produced, with differences in the light emission flux, CCT (correlated color temperature) or CRI (color rendering index) for example, it may be essential to develop a number of different supports equal to the number of possible combinations of values of the drive circuitry components required to meet the various objectives outlined above.

This may result in very considerable limitations, for example if it is desired to provide balancing of chains or strings of LEDs or protection against electrostatic discharge (ESD) phenomena.

### SUMMARY

It is therefore necessary to overcome the limitations outlined above.

Various embodiments have the purpose of meeting the aforesaid requirement.

In various embodiments, amounting support for solid-state light radiation sources is provided.

Various embodiments may also relate to a corresponding light source.

Various embodiments enable one or more of the following advantages to be obtained:
a compact, economical structure,
the possibility of adding components such as surface mount devices (SMDs) in areas of light sources such as LEDs which are normally available for this use (for example, those areas positioned in the vicinity of, or between, the light radiation sources),
the possibility of providing balancing for chains or strings of LEDs in parallel, and/or integrated protection against ESD phenomena, without increasing the surface of the board and/or having to add components on one and/or the other of the faces of the board.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 is a schematic illustration of a through hole in a printed circuit board,

FIGS. 2 and 3 show embodiments using a support as shown by way of example in FIG. 1, and

FIGS. 4 and 5 show possible details of construction of some embodiments.

### DETAILED DESCRIPTION

The following description illustrates various specific details intended to provide a deeper understanding of various embodiments. The embodiments may be produced without one or more of the specific details, or may use other methods, components, materials, or other elements. In other cases, known structures, materials or operations are not shown or described in detail, in order to avoid obscuring various aspects of the embodiments. The reference to “an embodiment” in this description is intended to indicate that a particular configuration, structure or characteristic described in relation to the embodiment is included in at least one embodiment. Therefore, phrases such as “in an embodiment”, which may be present in various parts of this description, do not necessarily refer to the same embodiment. Furthermore, specific formations, structures or characteristics may be combined in any suitable way in one or more embodiments. The references used herein are provided purely for convenience and therefore do not define the scope of protection or the extent of the embodiments.

In the drawings, particularly in FIG. 3, the reference 10 shows amounting support that can be used to provide a solid-state light source S including a regular or irregular array of solid-state light radiation sources (of the LED type, for example) 12, mounted on one face 10a of the support 10.

Light radiation sources of this type are known, and it is therefore unnecessary to provide a detailed description here. The reference to LED sources, having a CoB structure for example, must therefore be considered as merely exemplifying the possibilities of using solid-state light radiation sources in a source such as the source S.

In various embodiments, the support 10 may be in the form of a small disk, in other words in the form of a portion of plate having a circular contour. The choice of this shape is not essential: various embodiments may use a support 10 having a different shape, for example a square, rectangular, polygonal, elliptical, mixtilinear or other shape, depending on the desired distribution of the light radiation sources 12 which are used.

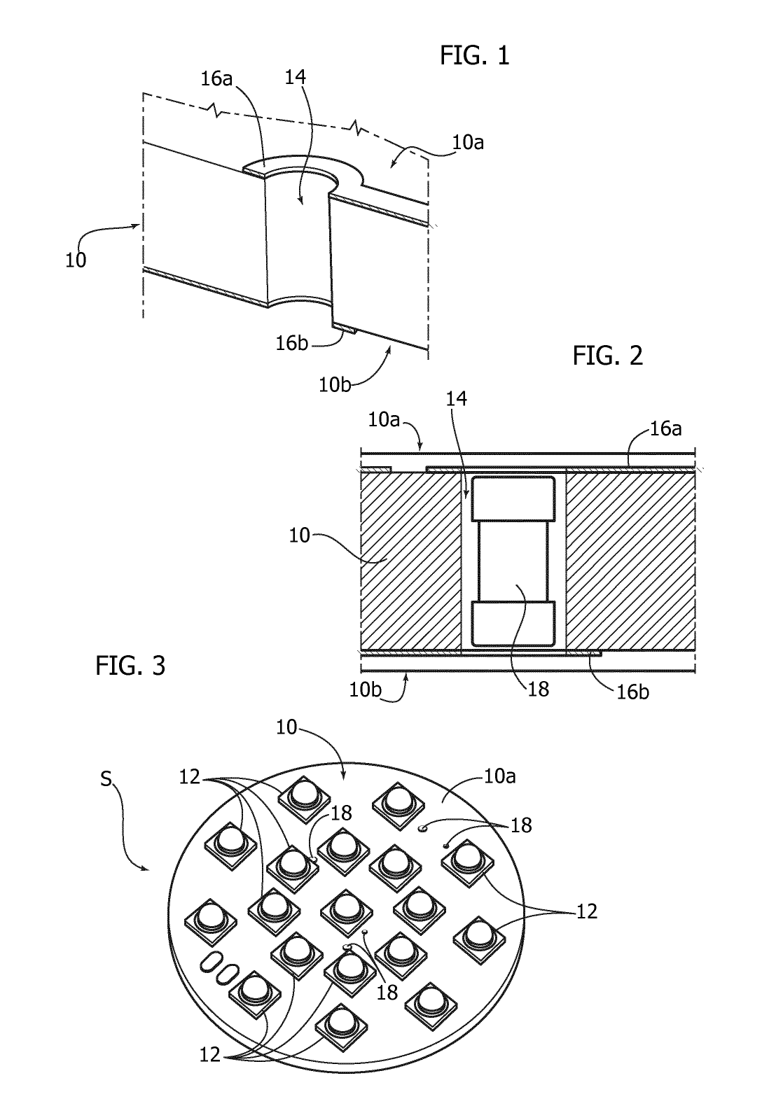

The view of FIG. 1 shows a portion of the board 10 which, according to a known solution for making printed circuit boards (PCBs), includes one or more through holes 14 which extend between the opposite faces 10a, 10b of the board 10. Holes of this type can be provided, for example, to allow the insertion of pins of the components mounted on the board in question, for example the power supply pins of light radiation sources such as the sources 12.

In various embodiments, holes such as the hole 14 of FIG. 1 may be unplated holes (in other words, holes without metallic coating) located between conductive lines or tracks 16a, 16b extending on both faces 10a, 10b of the board 10 at either end of the through hole 14.

In various embodiments, holes such as the hole 14 of FIG. 1 may be used for mounting at least one electrical component 18 of the drive circuitry of the light radiation sources 12 within the holes.

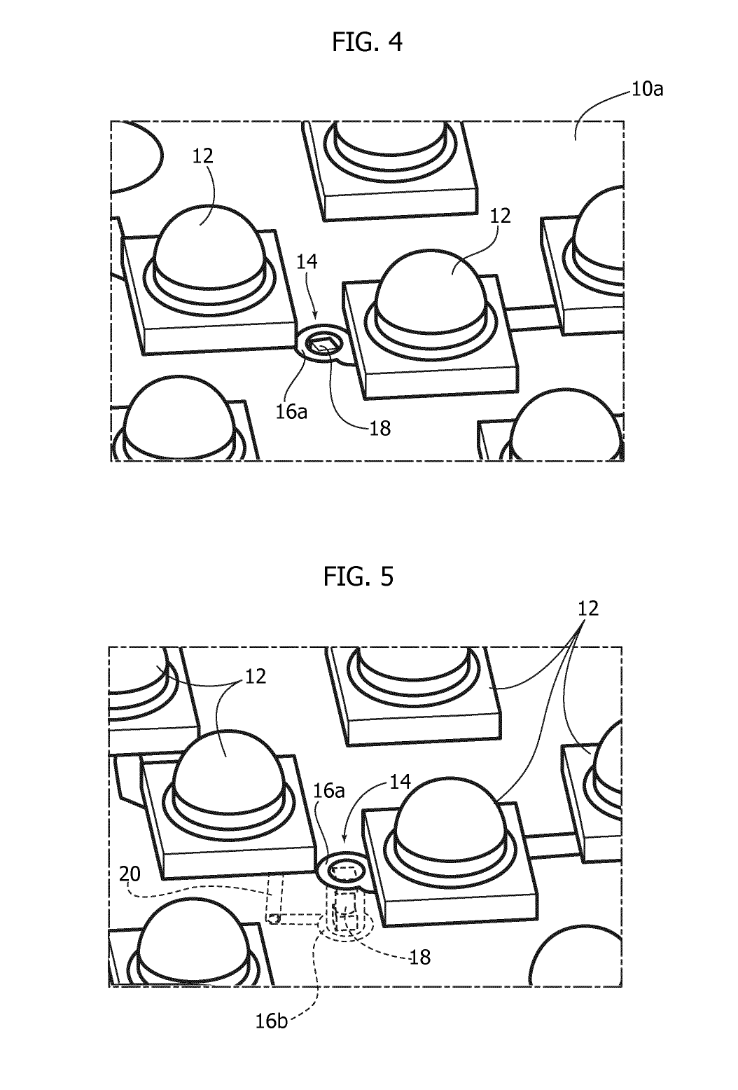

In various embodiments, components such as the component 18 visible in FIG. 2 (and, at least partially, in FIGS. 4 and 5) may be a component using SMD technology.

The component 18 can be connected to the tracks or lines 16a, 16b by known methods, for example by soldering or brazing, although this cannot be seen directly in FIGS. 2, 4 and 5.

Various embodiments therefore use through holes such as the hole 14 of FIG. 1 as mounting cavities in which electrical components 18 such as SMD components can be inserted (for example, “vertically”, that is to say in a direction orthogonal to the general plane of extension of the board 10).

The electrical connection of these components can be provided by means of conductive tracks or lines such as the lines or tracks 16a and 16b, made of copper for example, provided on the board 10.

Holes such as the hole 14 may be designed (in terms of the hole diameter and/or the thickness of the board, in other words the length or height of the hole 14) so as to be compatible with the standard casings or packages of components such as SMD components (for example, 0603, 0402, etc.).

For example (the reference to these specific dimensional parameters is purely by way of example), a board FR4 with a thickness of 1.2 mm having 35μ copper lines or tracks on both of its sides or faces 10a, 10b may be provided with one or more 0.7 mm diameter holes 14 to allow, for example, the mounting of resistors such as 0402 SMD resistors.

In various exemplary embodiments, the cross section of the hole 14 (which does not necessarily have a circular cross section) may allow adaptation to the shape and dimensions of the component 18 inserted into it.

In various embodiments, components such as resistors (or other components) can be connected by positioning them in close proximity to the light radiation sources 12, as shown schematically in FIGS. 4 and 5.

Thus the face 10a of the board intended to act as a light emitting surface (LES) is populated practically exclusively by the light radiation sources 12 and is left substantially free of other components. As shown by way of example in FIG. 3, the last-mentioned components only appear as “points” on the surface of the board, with a reduced, practically point-like footprint, and may if necessary even be covered by a source 12.

The illustration in FIG. 5 may be considered to be an imaginary transparent illustration of the board 10 intended to demonstrate the possibility of electrically connecting the sources 12 by using what are known as “vias” 20, in other words conductive connections extending over the length of through holes in the board 10.

In various embodiments, connections of this type (which are both electrically and thermally conductive) may make it possible to provide an additional effect by which the heat generated by the sources 12 is dissipated from face 10a to face 10b of the board 10, and therefore through the mounting support 10 of the sources 12, and from there toward a heat sink (such as a finned heat sink, not shown in the drawings) on which the light source S may be mounted.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. A mounting support for solid-state light radiation sources and for drive circuitry associated therewith, comprising:
a printed circuit board having a mounting surface for said light radiation sources, said printed circuit board having at least one through hole extending through it, and
at least one electrical component of said drive circuitry inserted in said at least one hole.

2. The support as claimed in claim 1, wherein said at least one hole is an unplated hole.

3. The support as claimed in claim 1, wherein said at least one electrical component is an SMD component.

4. The support as claimed in claim 1, wherein said printed circuit board carries electrical connection formations for said at least one electrical component extending over the opposite faces of the printed circuit board at both ends of said at least one through hole.

5. The support as claimed in claim 4, comprising at least one electrically conductive via extending through the printed circuit board to connect said electrical connection formations extending over the opposite faces of the printed circuit board.

6. A solid-state light source comprising:
a mounting support,
the mounting support for solid-state light radiation sources and for drive circuitry associated therewith, comprising:
a printed circuit board having a mounting surface for light radiation sources, said printed circuit board having at least one through hole extending through it, and
at least one electrical component of said drive circuitry inserted in said at least one hole, and
an array of solid-state light radiation sources mounted on said mounting surface.

7. The lighting source as claimed in claim 6, wherein said solid-state light radiation sources include LED sources.
